(19) United States
(12) Patent Application Publication
(10) Pub. No.: US 2005/0108942 A1
(43) Pub. Date: May 26, 2005

(54) Window lifter geared motor assembly

(76) Inventor: Gerard Fournier, Ifs (FR)

Correspondence Address: CARLSON, GASKEY & OLDS, P.C., 400 WEST MAPLE ROAD, SUITE 350, BIRMINGHAM, MI, 48009, US

(21) Appl. No.: 10/627,188

(22) Filed: Jul. 25, 2003

(30) Foreign Application Priority Data
Jul. 30, 2002 (FR) FR 02 09 683

(51) Int. Cl. E05F 15/02

(52) U.S. Cl. 49/28

(57) ABSTRACT

A window lifter geared motor assembly includes a drive shaft driven about an axis, a reduction gearset driven about an axis rotationally driven by the drive shaft, and a sensor. The output of the sensor is dependent upon a distance between the axis of the reduction gearset and the axis of the drive shaft. When the sensor detects an increased in the distance that exceeds a threshold value, operation of the geared motor assembly is interrupted. The assembly detects trapping that is likely to occur when an object, and particularly a hand, impedes the operation of the window.

This application claims priority to French patent application No.FR 02 09 683 filed on Jul. 30, 2002.

### BACKGROUND OF THE INVENTION

The present invention relates generally to a window lifter geared motor assembly including a sensor that detects the separation between an axis of a drive shaft and an axis of a reduction gearset to detect the presence of a trapped object.

Numerous motor vehicle equipment items are operated using geared motor assembly electric motors. For example, window lifter windows are increasingly driven by electric motors. It is possible for an object or a person's hand to accidentally lie in the closure path of the window and become trapped between the top edge of the window and the surround in the door, possibly resulting in damage or injury. Various devices for forcing the window to be lowered are known.

Thus, document U.S. Pat. No. 5,296,658 uses window seals containing capacitances or optical fibers. The characteristics of these seals are modified when an object is trapped, providing a trapping signal that acts on the window drive. However, these seals are expensive and detrimental to the aesthetics of the vehicle because they are bulky and visible.

Document DE-A-3 034 114 proposes to measure the rotational speed of the electric motor. Document DE-A-4 442 171 proposes measuring the electric current of the electric motor. However, these methods have disadvantages. Because of the characteristics of the electric motor, particularly its inertia, its resistance, or its flux, there is a relatively long response time between the trapping of an object and the detection of this trapping. The force driving the window may, in the meantime, increase appreciably and cause injury. The trapping force may also exceed the levels defined in the standards, making vehicle homologation difficult.

There is therefore a need for a geared motor assembly able to solve the problem of detecting an object trapped in a window lifter.

### SUMMARY OF THE INVENTION

The invention provides a window lifter geared motor assembly including a drive shaft, a reduction gearset rotationally driven by the drive shaft, and a sensor. The state of the sensor is a function of the separation between an axis of the reduction gearset and an axis of the drive shaft.

According to one embodiment, the reduction gearset can be rotationally driven about a reduction shaft that is guided with respect to a casing by a bearing on which the sensor is located. According to another embodiment, the drive shaft can be guided with respect to the casing by a bearing on which the sensor is located.

Preferably, the driving of the drive shaft is a function of the state of the sensor. In one example, the sensor is a piezoresistive sensor.

According to another embodiment, the geared motor assembly further includes an electric motor in the casing that rotationally drives the drive shaft and a damper that dampens the movements of the electric motor in the casing.

In one example, the damper is a spring positioned between the casing and the electric motor. The invention also relates to a window lifter including the geared motor assembly as described hereinabove.

Other features and advantages of the invention will become apparent from reading the detailed description that follows of some embodiments of the invention given solely by way of example and with reference to the drawings.

### BRIEF DESCRIPTION OF THE DRAWINGS

FIG. 1 shows a cross-sectional view of the geared motor assembly of the present invention;

FIG. 2 shows a top view of the geared motor; and

FIG. 3 shows a front view of the geared motor.

### DETAILED DESCRIPTION OF THE PREFERRED EMBODIMENT

The invention relates to a window lifter geared motor assembly 1 including a drive shaft 5 that drives a reduction gearset 7 and a sensor 8. The state of the sensor 8 is a function of the separation between the drive shaft 5 and the reduction gearset 7. When the reduction gearset 7 is blocked in its rotation because of the presence of an object across the path of the window, the force developed by the geared motor assembly 1 to overcome the presence of the obstacle is proportional to the force that causes an increase in separation 23 of an axis 20 of the drive shaft 5 and an axis 6 of the reduction gearset 7. By detecting the increase in separation 23, the sensor 8 is able to unambiguously detect the trapping of an object in the path of the window.

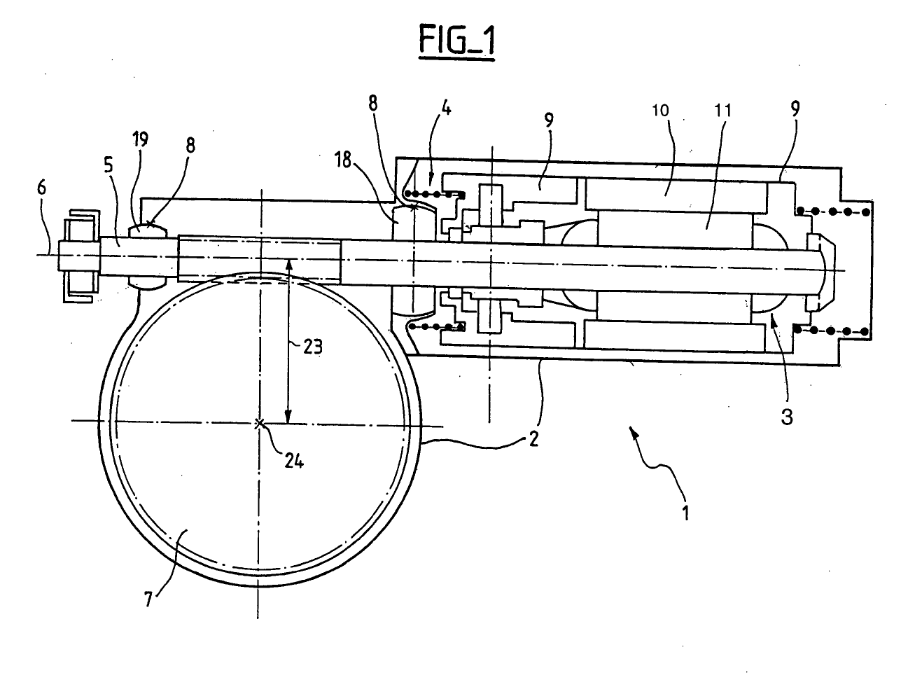

FIG. 1 shows a cross-sectional view of the geared motor assembly 1 of the present invention. The geared motor assembly 1 includes an electric motor 3 in a casing 2 that rotationally drives the drive shaft 5 via a rotor 11 and a stator 10. The drive shaft 5 is rotationally driven about the axis 6 to rotationally drive the reduction gearset 7.

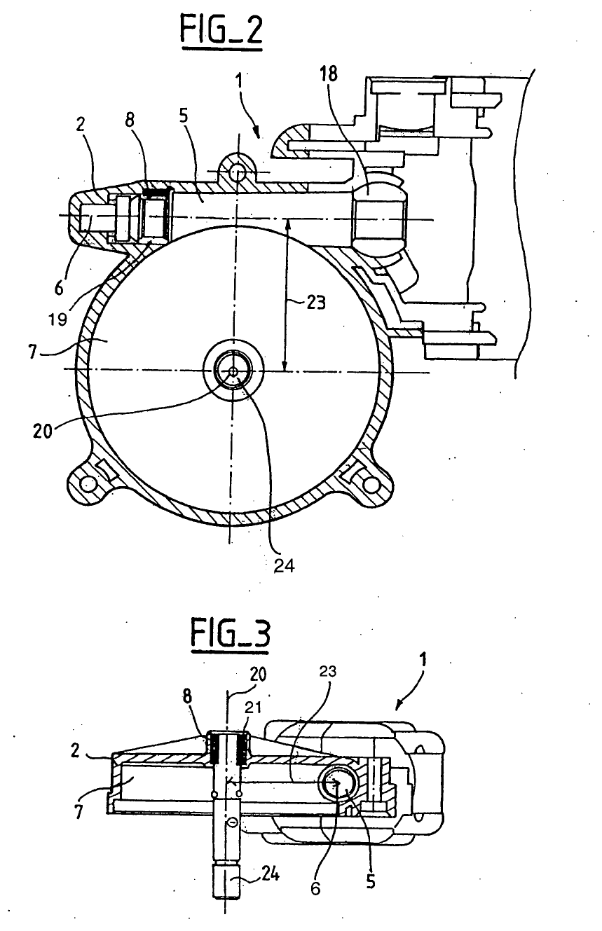

In one example, the connection between the drive shaft 5 and the reduction gearset 7 is a worm and wheel connection. The reduction gearset 7 is a toothed wheel rotationally driven by a screw thread on the drive shaft 5. The reduction gearset 7 is rotationally driven about the axis 20 (shown in FIG. 2). The axis 20 of the reduction gearset 7 and the axis 6 of the drive shaft 5 are orthogonal. In the worm and wheel connection, the tooth separation force is one of the components of the forces involved in the driving of the wheel by the worm. It is proportional to the torque developed by the geared motor assembly 1. The tooth separation force is in a direction orthogonal to the axis 6 and to the axis 20. It is manifested in an increase in separation 23 between the two axes 6 and 20.

The sensor 8 detects the tooth separation force, making it possible to detect the forces applied at the output to the reduction gearset 7. As long as the separation 23 between the axes 6 and 20 remains within a predetermined threshold, the corresponding tooth separation force will be due to the development of a torque representative of normal operation of the geared motor assembly 1. This corresponds to unimpeded operation of the window lifter. By contrast, when the sensor 8 is in a state that indicates an increase in the separation 23 and, in particular, when the state of the sensor 8 indicates that the separation 23 is exceeding the predetermined threshold, the corresponding tooth separation caused by the development of an operating torque that is abnormal for the geared motor assembly 1. The geared motor assembly 1 develops a higher torque to overcome an obstacle impeding the path of the window. The increase in the developed torque increases the separation 23 and is detected by the sensor 8.

Preferably, the driving of the drive shaft 5 is a function of the state of the sensor 8. When the sensor 8 detects an increase in the separation 23, and therefore the crossing of the predetermined threshold of separation of a tooth on the drive shaft 5 and the reduction gearset 7, operation of the geared motor assembly 1 is allowed to be interrupted. A circuit (not illustrated) processes the state of the sensor 8 and is able to stop the operation of the electric motor 3. This prevents an object impeding the path of the window from being trapped. This is particularly advantageous when a finger is in the path of the window, avoiding any injury. Additionally, when an object impedes the path of the window, the reduction gearset 7 driving the window lifter cable winding drum is blocked in its rotation. The blockage of the reduction gearset 7 may damage the worm and wheel connection. By interrupting the operation of the electric motor 3, the link and the geared motor assembly 1 can be protected. Another advantage is that the window closure force can be monitored and thus spare the mechanical stops of the window lifter.

Advantageously, the circuit for processing the state of the sensor 8 reverses operation of the geared motor assembly 1. This allows the window to be lowered and the object impeding the path of the window to be disentangled.

FIGS. 2 and 3 show various possible locations for the sensor 8 on the geared motor assembly 1. Preferably, the sensor 8 is arranged on elements of the geared motor assembly 1 that are not in motion when the geared motor assembly 1 is in operation. The advantage is that the sensor 8 can be connected more easily to the circuit for processing the state of the sensor 8 than it could be if the sensor 8 were driven back and forth.

FIG. 2 shows a top view of the geared motor assembly 1 of FIG. 1. In this embodiment, the drive shaft 5 is guided with respect to the casing 2 by bearings 18 and 19. The sensor 8 is arranged on the bearing 19 that guides the drive shaft 5. The sensor 8 can also be arranged on both the bearings 18 and 19, thus improving detection of the increase in separation 23. The increase in the separation 23 between the axes 6 and 20 gives rise to a load in the bearings 18 and 19. This load corresponds to the tooth separation force and is detected by the sensor 8.

FIG. 3 shows a front view of the geared motor assembly 1 of FIG. 1. The reduction gearset 7 is rotationally driven about a reduction shaft 24 guided with respect to the casing 2 by a bearing 21 on which the sensor 8 is located. The increase in the separation 23 between the axes 6 and 20 gives rise to a load in the bearing 21 that guides the reduction shaft 24 in the casing 2. This load corresponds to the tooth separation force and is detected by the sensor 8. The sensor 8 is also depicted in FIG. 1 as being located on the bearing 18.

The variation in the state of the sensor 8 as a function of the separation 23 makes it possible to detect the trapping of an object without having to measure an intermediate parameter, such as the rotational speed of the electric motor 3 or the electric current in the electric motor 3.

It is possible, for example, to use a piezoresistive sensor 8 known per se and commercially available. The electrical impedance of the sensor 8 increases in proportion to the load applied to its two faces. It is also possible to use a sensor 8 exhibiting a capacitance, an inductance, or more generally an impedance. The value of the sensor 8 varies as a function of the load applied to it. Such a sensor 8 is compact and may have terminals ready for connection. The response time of the sensors 8 is preferably shorter than 25 ms.

Preferably, the geared motor assembly 1 includes a damper 4, as depicted in FIG. 1. The damper 4 dampens the movements of the electric motor 3 in the casing 2 and prevents damage to the geared motor assembly 1 when it becomes blocked by an object in the path of the window. In particular, the damper 4 makes it possible to avoid breakage of part of the reduction gearset 7, such as the meshing teeth. The damper 4 is able to dampen movement of the drive shaft 5 when the reduction gearset 7 is rotationally blocked by the presence of an obstacle. The damper 4 can be positioned on either side of the electric motor 3, depending on the desired direction of damping. Preferably, the damper 4 is positioned on both sides of the electric motor 3.

For unambiguous detection by the sensor 8 of the blocking of a window, it is preferable for the driveline between the obstacle on the window and the sensor 8 to be “rigid.” The term “driveline” is to be understood in a window lifter to mean the sequence including the window, the slider on the window, the cable, the drum, the reduction gearset 7, the drive shaft 5 and the electric motor 3. Instead of the drum and the cable, the window lifter can comprise a pinion and a sector arm.

Preferably, the damper 4 is a spring positioned between the casing 2 and the electric motor 3. More specifically, the spring 4 is positioned between the casing 2 and the envelope 9 of the electric motor 3. The advantage is that the rigidity of the driveline is not interrupted. Thus, the presence of the sensor 8 on a bearing that guides the drive shaft 5 or the reduction shaft 24 of the reduction gearset 7 is able to quickly and unambiguously detect the presence of an obstacle in the path of the window.

The invention also relates to a window lifter comprising such a geared motor assembly 1. All the advantages described hereinabove are repeated in the case of the window lifter. Such a window lifter allows unambiguous detection of the trapping. This allows the window lifter to meet the standards in force.

Of course, the present invention is not limited to the embodiments described by way of example; thus, the geared motor assembly described may be the one used to operate a sunroof. It may also be used to move a car seat. The invention is particularly advantageous when the leg of a rear-seat passenger impedes the sliding of the seat.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A window lifter geared motor assembly comprising:
a drive shaft driven about a drive shaft axis;
a reduction gearset rotationally driven by said drive shaft, said reduction gearset driven about a reduction gearset axis; and
a sensor having a state dependent upon a distance between said reduction gearset axis and said drive shaft axis.

2. The geared motor assembly according to claim 1, wherein said reduction gearset is rotationally driven about a reduction shaft, said reduction shaft being supported with respect to a casing by a bearing, and said sensor is located on said bearing.

3. The geared motor assembly according to claim 1, wherein said drive shaft is supported with respect to a casing by a bearing, and said sensor is located on said bearing.

4. The geared motor assembly according to claim 1, wherein said state of said sensor determines whether said drive shaft is driven.

5. The geared motor assembly according to claim 1, wherein said sensor is a piezoresistive sensor.

6. The geared motor assembly according to claim 1, wherein said assembly further comprises an electric motor rotationally driving said drive shaft.

7. The geared motor assembly according to claim 6 wherein said electric motor is in a casing, and further including a damper that dampens movements of said electric motor in said casing.

8. The geared motor assembly according to claim 7, wherein said damper is a spring positioned between said casing and said electric motor.

9. The geared motor assembly according to claim 1 wherein operation of the window lifter geared motor assembly is stopped when said sensor detects that said distance exceeds a threshold value.

10. The geared motor assembly as recited in claim 1 wherein operation of the window lifter geared motor assembly is reversed when said sensor detects that said distance exceeds a threshold value.

11. The geared motor assembly as recited in claim 1 wherein said drive shaft and said reduction gearset have a worm and a wheel connection.

12. A method of detecting a object trapped in a window lifter geared motor assembly comprising the steps of:
providing a drive shaft having a drive shaft axis;
providing a reduction gearset having a reduction gearset axis; and
sensing a distance between said drive shaft axis and said reduction gearset axis.

13. The method as recited in claim 12 further including the step of stopping operation of the window lifter geared motor assembly when said distance exceeds a threshold value.

14. The method as recited in claim 12 further including the steps of providing an electric motor in a housing that drives said drive shaft and damping movements of said electric motor in said housing;

15. The method as recited in claim 12 further including the step of reversing operation of the window lifter geared motor assembly when said distance exceeds said threshold value.

16. The method as recited in claim 12 wherein the step of sensing is performed by a sensor.

17. The method as recited in claim 16 further including the step of supporting said drive shaft with a bearing, and said sensor is positioned on said bearing.

18. The method as recited in claim 16 further including the steps of rotationally driving said reduction gearset about a reduction shaft and supporting said reduction shaft with a bearing, and said sensor is positioned on said bearing.
